(19) United States
(12) Patent Application Publication
(10) Pub. No.: US 2016/0116871 A1
(43) Pub. Date: Apr. 28, 2016

(54) FIXING DEVICE AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventors: Kazuhiko Kikuchi, Yokohama (JP); Hiroyuki Kunugi, Numazu (JP)

(21) Appl. No.: 14/521,524

(22) Filed: Oct. 23, 2014

(51) Int. Cl. G03G 15/20

(52) U.S. Cl. CPC G03G 15/2053

(57) ABSTRACT

In accordance with one embodiment, a fixing device comprises an induction current generation section, a fixing belt, an auxiliary heating section, a concave portion and lubricant. The induction current generation section generates induction current. The fixing belt is formed into an endless belt having a heating layer which generates heat through the induction current. The auxiliary heating section is contacted with the inner peripheral surface of the fixing belt to assist in the heating of the heating layer based on the induction current. The concave portion is formed in the auxiliary heating section to face the inner peripheral surface of the fixing belt. The lubricant is injected into the concave portion.

### FIELD

Embodiments described herein relate generally to a fixing device and an image forming apparatus.

### BACKGROUND

Conventionally, there is a multi function peripheral (hereinafter referred to as an “MFP”) and an image forming apparatus such as a printer and the like. The image forming apparatus is provided with a fixing device. The fixing device heats a fixing belt through an electromagnetic induction heating method (hereinafter referred to as an “IH method”). The fixing device fixes a toner image on an image receiving medium through the heat of the fixing belt. The fixing belt includes a heating layer which generates heat through induction current. The fixing device reduces the heat capacity of the fixing belt to reduce the waiting time such as the warming up time and the time taken to resume from sleep. The fixing device contacts an auxiliary heating section with the inner peripheral surface of the fixing belt to suppress the temperature unevenness of the fixing belt. However, if the auxiliary heating section is contacted with the inner peripheral surface of the fixing belt, there is a possibility that the rotation of the fixing belt becomes harder due to the frictional resistance, and the fixing operation cannot be speeded up.

### BRIEF DESCRIPTION OF THE DRAWINGS

FIG. 1 is a side view of an image forming apparatus according to a first embodiment;

FIG. 2 is a side view of a fixing device including the control block of an IH coil unit according to the first embodiment;

FIG. 3 is a schematic view illustrating the layer structure of a fixing belt according to the first embodiment;

FIG. 4 is a perspective view illustrating the IH coil unit according to the first embodiment;

FIG. 5 is an illustration diagram illustrating the length of a concave portion of an auxiliary heating plate in the width direction of the fixing belt according to the first embodiment;

FIG. 6 is a side view illustrating a state in which the auxiliary heating plate is contacted with the inner peripheral surface of the fixing belt according to the first embodiment;

FIG. 7 is a side view illustrating a state in which the auxiliary heating plate is separated from the inner peripheral surface of the fixing belt according to the first embodiment;

FIG. 8 is a block diagram illustrating a control system mainly for the control of the IH coil unit according to the first embodiment;

FIG. 9 is a flowchart illustrating the control of the fixing device according to the first embodiment;

FIG. 10 is a flowchart illustrating the control of a fixing device according to a second embodiment;

FIG. 11 is a side view of the main portions of a fixing device according to a third embodiment;

FIG. 12 is a side view illustrating a state in which an auxiliary heating plate is contacted with the inner peripheral surface of a fixing belt according to a fourth embodiment; and

FIG. 13 is a side view illustrating a state in which the auxiliary heating plate is separated from the inner peripheral surface of the fixing belt according to the fourth embodiment.

### DETAILED DESCRIPTION

In accordance with one embodiment, a fixing device comprises an induction current generation section, a fixing belt, an auxiliary heating section, a concave portion and lubricant. The induction current generation section generates induction current. The fixing belt is formed into an endless belt having a heating layer which generates heat through the induction current. The auxiliary heating section is contacted with the inner peripheral surface of the fixing belt to assist in the heating of the heating layer based on the induction current. The concave portion is formed in the auxiliary heating section to face the inner peripheral surface of the fixing belt. The lubricant is injected into the concave portion.

Hereinafter, an image forming apparatus 10 according to the first embodiment is described with reference to the accompanying drawings. In addition, the same components are indicated by the same reference numerals in the drawings.

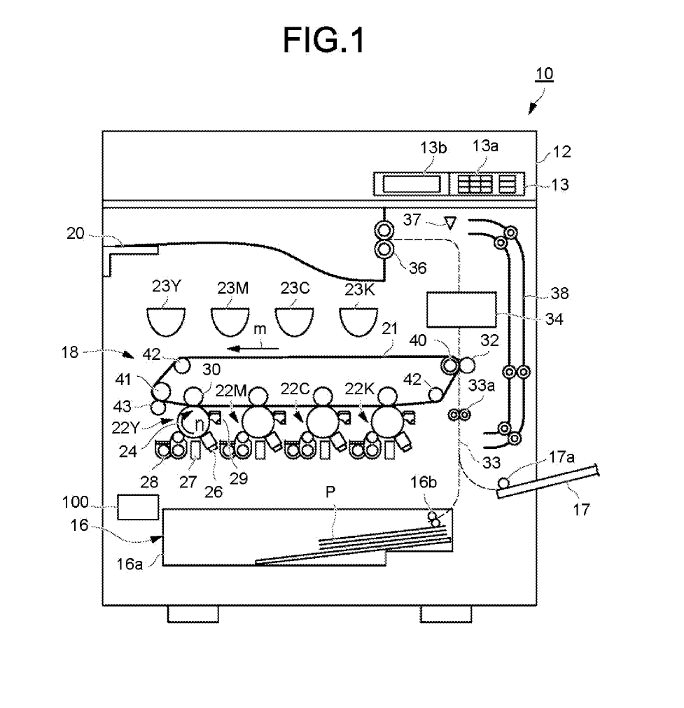

FIG. 1 is a side view of the image forming apparatus 10 according to the first embodiment. Hereinafter, an MFP 10 is exemplified as one example of the image forming apparatus 10.

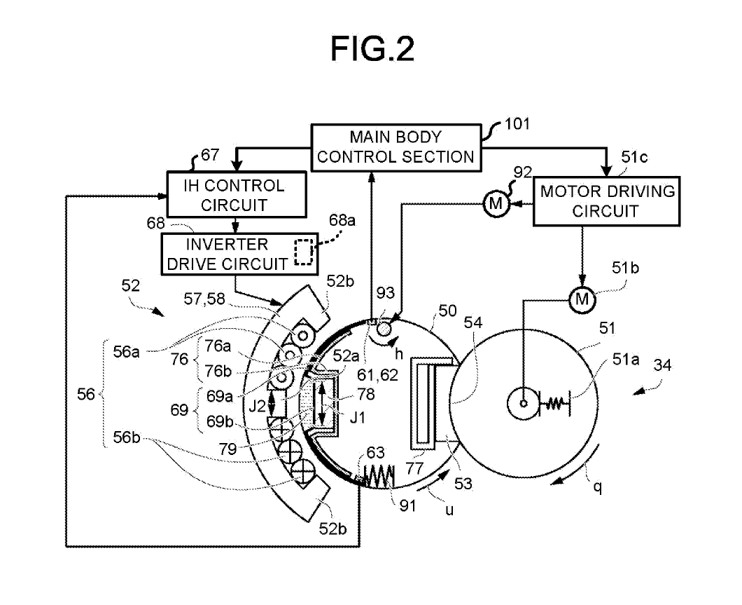

As shown in FIG. 1, the MFP 10 includes a scanner 12, a control panel 13 and a printer section 18. The MFP 10 includes a CPU 100 for controlling the whole system of the scanner 12, the control panel 13 and the printer section 18. The printer section 18 is controlled by a main body control section 101 (refer to FIG. 2). The main body control section 101 operates according to a command of the CPU 100.

The scanner 12 reads a document image for the image formation by the printer section 18. The control panel 13 includes input keys 13a and a display section 13b. For example, the input keys 13a receive an input from a user. For example, the display section 13b is a touch panel type display. The display section 13b receives an input from the user and displays information to the user.

The printer section 18 includes a paper feed cassette section 16, a paper feed tray 17 and a paper discharge section 20. The paper feed cassette section 16 includes a paper feed cassette 16a and a pickup roller 16b. The paper feed cassette 16a stores a sheet P serving as an image receiving medium. The pickup roller 16b picks up the sheet P from the paper feed cassette 16a.

The paper feed cassette 16a feeds a sheet P. The paper feed tray 17 feeds a sheet P through a pickup roller 17a.

The printer section 18 includes an intermediate transfer belt 21. The printer section 18 supports the intermediate transfer belt 21 with a backup roller 40, a driven roller 41 and a tension roller 42. The backup roller 40 includes a driving section (not shown). The printer section 18 rotates the intermediate transfer belt 21 in a direction indicated by an arrow m.

The printer section 18 includes four image forming stations 22Y, 22M, 22C and 22K, each of which forms a Y (yellow), M (magenta), C (cyan) and K (black) image, respectively. The image forming stations 22Y, 22M, 22C and 22K are arranged side by side below the intermediate transfer belt 21 along the rotation direction of the intermediate transfer belt 21.

The printer section 18 includes a cartridge 23Y, 23M, 23C and 23K above each of the image forming stations 22Y, 22M, 22C and 22K. The cartridges 23Y, 23M, 23C and 23K stores Y (yellow), M (magenta), C (cyan) and K (black) toner for replenishment, respectively.

Hereinafter, the Y (yellow) image forming station 22Y within the image forming stations 22Y, 22M, 22C and 22K is exemplified. In addition, the image forming stations 22M, 22C and 22K are structurally identical to the image forming station 22Y, and therefore, the detailed description thereof is not repeated.

The image forming station 22Y includes an electrostatic charger 26, an exposure scanning head 27, a developing device 28 and a photoconductor cleaner 29. The electrostatic charger 26, the exposure scanning head 27, the developing device 28 and the photoconductor cleaner 29 are arranged around a photoconductive drum 24 which rotates in a direction indicated by an arrow n.

The image forming station 22Y includes a primary transfer roller 30 opposite to the photoconductive drum 24 across the intermediate transfer belt 21.

The image forming station 22Y exposes the photoconductive drum 24 with the exposure scanning head 27 after charges the photoconductive drum 24 with the electrostatic charger 26. In this way, the image forming station 22Y forms an electrostatic latent image on the photoconductive drum 24. The developing device 28 develops the electrostatic latent image on the photoconductive drum 24 with the two-component developing agent including the toner and carrier.

The primary transfer roller 30 primarily transfers the toner image formed on the photoconductive drum 24 to the intermediate transfer belt 21. The image forming stations 22Y, 22M, 22C and 22K form a color toner image on the intermediate transfer belt 21 through the primary transfer roller 30. The color toner image is formed by overlapping the Y (yellow), M (magenta), C (cyan) and K (black) toner images in sequence. The photoconductor cleaner 29 removes the toner left on the photoconductive drum 24 after the primary transfer.

The printer section 18 further includes a secondary transfer roller 32 opposite to the backup roller 40 across the intermediate transfer belt 21. The secondary transfer roller 32 secondarily transfers the color toner images on the intermediate transfer belt 21 to the sheet P collectively. The sheet P is fed from the paper feed cassette section 16 or the manual feeding tray 17 along a conveyance path 33.

The printer section 18 includes a belt cleaner 43 opposite to the driven roller 41 across the intermediate transfer belt 21. The belt cleaner 43 removes the toner left on the intermediate transfer belt 21 after the secondary transfer. In addition, the image forming section includes the intermediate transfer belt 21, the four image forming stations 22Y, 22M, 22C and 22K, and the secondary transfer roller 32.

The printer section 18 includes a register roller 33a, a fixing device 34 and a paper discharge roller 36 along the conveyance path 33. The printer section 18 includes a branch section 37 and a reversal conveyance section 38 at the downstream side of the fixing device 34. The branch section 37 guides the sheet P subjected to fixing processing to the paper discharge section 20 or the reversal conveyance section 38. In a case of duplex printing, the reversal conveyance section 38 reversely conveys the sheet P guided by the branch section 37 to the direction of the register roller 33a. The MFP 10 forms a fixed toner image on the sheet P with the printer section 18 and then discharges the sheet P to the paper discharge section 20.

In addition, the MFP 10 is not limited to the tandem development type, and the number of the developing devices 28 is not limited. Further, the MFP 10 may directly transfer the toner image to the sheet P from the photoconductive drum 24. Further, the printer section 18 may form an image with inerasable toner and erasable toner.

Hereinafter, the fixing device 34 is described in detail.

FIG. 2 is a side view of the fixing device 34 including the control block of an IH coil unit 52 according to the first embodiment.

As shown in FIG. 2, the fixing device 34 includes a fixing belt 50, a pressing roller 51, the electromagnetic induction heating coil unit 52 and a driving section 90. The electromagnetic induction heating coil unit 52 is an induction current generation section. Hereinafter, the electromagnetic induction heating coil unit is referred to as the “IH coil unit”.

The fixing belt 50 is a cylindrical endless belt. A nip pad 53, an auxiliary heating plate 69 serving as an auxiliary heating section, a shield 76 serving as a support member, a heat pipe 78, an elastic member 91 and an axis 93 are arranged inside the fixing belt 50. Further, a center thermistor 61, an edge thermistor 62, a thermostat 63 and a stay 77 are arranged inside the fixing belt 50. The shield 76 supports the auxiliary heating plate 69 and the heat pipe 78. The stay 77 supports the nip pad 53.

The fixing belt 50 is driven, through the rotation of the pressing roller 51, to rotate in a direction indicated by an arrow u, alternatively, the fixing belt 50 is rotated in a direction indicated by an arrow u independently. In a case in which the fixing belt 50 and the pressing roller 51 are rotated independently, an one-way clutch may be arranged so that no speed difference between the fixing belt 50 and the pressing roller 51 occurs.

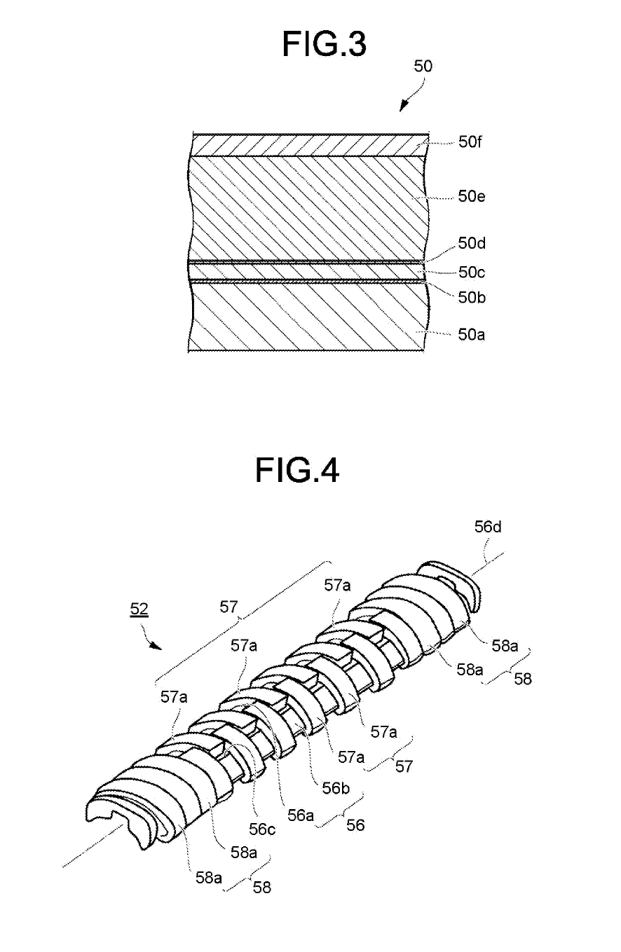

FIG. 3 is a schematic view illustrating the layer structure of the fixing belt 50 according to the first embodiment.

As shown in FIG. 3, the fixing belt 50 includes a base layer 50a, an adhesive layer 50b, a heating layer 50c, a protective layer 50d, an elastic layer 50e and a release layer 50f. The fixing belt 50 is formed by laminating the adhesive layer 50b, the heating layer 50c, the protective layer 50d, the elastic layer 50e and the release layer 50f on the base layer 50a in sequence. In addition, the fixing belt 50 is not limited to a layer structure as long as the fixing belt 50 includes the heating layer 50c.

For example, the base layer 50a is formed by polyimide (PI) resin; the heating layer 50c is formed by nonmagnetic metal such as copper (Cu) and the like; the protective layer 50d is formed by nickel (Ni) and the like; the elastic layer 50e is formed by an elastic material such as silicone rubber; and the release layer 50f is formed by fluororesin such as copolymer (PFA) resin of tetrafluoroethylene and perfluoro alkyl vinyl ether.

The heating layer 50c is thinned to reduce the heat capacity so that the fixing belt 50 can carry out warming up rapidly. The fixing belt 50 with low heat capacity can reduce the time required for the warming up operation and save the consumption of power.

For example, the fixing belt 50 sets the thickness of the copper layer of the heating layer 50c to 10 μm to reduce the heat capacity thereof. For example, the heating layer 50c is covered by the protective layer 50d such as a nickel layer and the like. The protective layer such as a nickel layer suppresses the oxidation of the copper layer and meanwhile improves the mechanical strength of the copper layer.

In addition, the heating layer 50c may be formed by carrying out electroless nickel plating and copper plating on the base layer 50a formed by the polyimide resin. The adhesion strength between the base layer 50a and the heating layer 50c and the mechanical strength of the heating layer 50c can be improved through the electroless nickel plating.

Further, the surface of the base layer 50a may be roughened through a sandblasting processing or a chemical etching processing. In this way, the adhesion strength between the base layer 50a and the nickel plating of the heating layer 50c can be further improved mechanically.

Further, metal such as titanium (Ti) and the like may be dispersed on the polyimide resin forming the base layer 50a. In this way, the adhesion strength between the base layer 50a and the nickel plating of the heating layer 50c can be further improved.

For example, the heating layer 50c is formed by nickel, iron (Fe), stainless steel, aluminum (Al), silver (Ag) and the like. The heating layer 50c may be an alloy formed with two or more categories of metals; alternatively, the heating layer 50c may be formed by overlapping two or more categories of metals in a layer shape.

The heating layer 50c generates eddy current through the magnetic flux generated by the IH coil unit 52. The heating layer 50c generates joule heat through the eddy current and the electrical resistance of the heating layer 50c to heat the fixing belt 50.

FIG. 4 is a perspective view illustrating the IH coil unit 52 according to the first embodiment.

As shown in FIG. 4, the IH coil unit 52 includes coils 56, a first core 57 and a second core 58.

The coils 56 generate magnetic flux. The coils 56 are opposite to the fixing belt 50. The longitudinal direction of the coils 56 corresponds to the width direction (hereinafter referred to as a “belt width direction”) of the fixing belt 50.

The first core 57 and the second core 58 covers the side (hereinafter referred to as “back side”) of the coils 56 opposite to the fixing belt 50. The first core 57 and the second core 58 prevent the magnetic flux generated by the coil 56 from being leaked from the back side, and concentrate the magnetic flux generated by the coil 56 to the fixing belt 50.

The first core 57 includes a plurality of single wing parts 57a which are alternately arranged in a staggered manner by taking a center line 56d along the longitudinal direction of the coil 56 as an axis of symmetry. The second core 58 is arranged at each of the both sides of the first core 57. The second core 58 includes a plurality of two wings parts 58a straddling both wings of the coil 56. For example, the single wing part 57a and the two wings part 58a are formed with magnetic materials such as nickel-zinc alloy (Ni—Zn), manganese-nickel alloy (Mn—Ni) and the like.

The first core 57 alternately regulates, with the plurality of single wing parts 57a, the magnetic flux generated by the coil 56 for each single wing of the coil 56 with the center line 56d taken as an axis of symmetry. The first core 57 concentrates the magnetic flux generated by the coil 56 to the fixing belt 50 with the plurality of single wing parts 57a.

The second core 58 regulates, with the plurality of two wings parts 58a, the magnetic flux generated by the coil 56 for the two wings of the coil 56 at the two sides of the first core 57. The second core 58 concentrates the magnetic flux generated by the coil 56 to the fixing belt 50 with the plurality of two wings parts 58a. The magnetic flux concentration force of the second core 58 is stronger than that of the first core 57.

As shown in FIG. 2, the IH coil unit 52 generates induction current when the fixing belt 50 is rotated in a direction indicated by an arrow u. Through the induction current, the heating layer 50c of the fixing belt 50 facing the IH coil unit 52 generates heat.

For example, the coil 56 may be a litz wire which is formed by bundling a plurality of copper wire materials covered by heat-resistant polyamide-imide serving as an insulation material. The coil 56 is formed by circulating a conductive coil. As shown in FIG. 4, the coil 56 includes first wings 56a and second wings 56b. The first wings 56a are arranged at one side of the center line 56d, while the second wings 56b are arranged at the other side of the center line 56d. A window portion 56c is formed at the center in the longitudinal direction of the coil 56, that is, the space between the first wings 56a and the second wings 56b.

As shown in FIG. 2, the coil 56 generates the magnetic flux through the application of high-frequency current from an inverter drive circuit 68. For example, the inverter drive circuit 68 includes an IGBT (Insulated Gate Bipolar Transistor) element 68a.

A first convex portion 52a and two second convex portions 52b are formed in the IH coil unit 52 to protrude from the outside of the fixing belt 50 towards the fixing belt 50. The first convex portion 52a is arranged between the first wing 56a and the second wing 56b. The second convex portions 52b are arranged opposite to the first convex portion 52a across the first wing 56a and the second wing 56b. The IH coil unit 52 concentrates the magnetic flux generated by the coil 56 to the fixing belt 50 through the first convex portion 52a and the second convex portion 52b.

The auxiliary heating plate 69 includes a main body portion 69a and a concave portion 69b. The main body portion 69a faces the first wing 56a and the second wing 56b across the fixing belt 50. An elastic member 91 such as a spring and the like is arranged on the main body portion 69a. The main body portion 69a abuts against the inner peripheral surface of the fixing belt 50 through the elastic force of the elastic member 91. The main body portion 69a is formed into an arc shape along the inner peripheral surface of the fixing belt 50.

The concave portion 69b is recessed inward in the radial direction of the fixing belt 50 compared with the main body portion 69a. The concave portion 69b faces the inner peripheral surface of the fixing belt 50. The concave portion 69b faces the first convex portion 52a across the fixing belt 50. Lubricant 79 is injected into the concave portion 69b.

The lubricant 79 is oil formed with silicon or fluorine and the like. The lubricant 79 lubricates the inner peripheral surface of the fixing belt 50 to reduce the frictional resistance between the inner peripheral surface of the fixing belt 50 and the auxiliary heating plate 69. The lubricant 79 further reduces the frictional resistance between the inner peripheral surface of the fixing belt 50 and the nip pad 53.

A length J1 of the concave portion 69b along the rotation direction of the fixing belt 50 is longer than a length J2 of the first convex portion 52a along the rotation direction of the fixing belt 50. The length J1 of the concave portion 69b is a length parallel to a tangent direction of the inner peripheral surface of the fixing belt 50 in an area opposite to the first convex portion 52a. The length J2 of the first convex portion 52a is a length parallel to a tangent direction of the inner peripheral surface of the fixing belt 50 in an area opposite to the concave portion 69b.

The auxiliary heating plate 69 generates heat through the induction current generated by the IH coil unit 52. For example, the auxiliary heating plate 69 is formed by a magnetic material such as SUS420 serving as martensitic stainless steel.

The auxiliary heating plate 69 generates eddy current through the magnetic flux generated by the IH coil unit 52 to generate heat. The auxiliary heating plate 69 assists in the heating of the heating layer 50c of the fixing belt 50 based on the IH coil unit 52. The auxiliary heating plate 69 assists in the heating of the fixing belt 50.

In addition, the auxiliary heating plate 69 may be formed by a plate-shaped member having the magnetic properties of iron or nickel and the like. Alternatively, the auxiliary heating plate 69 may be formed by a material such as the resin and the like containing magnetic powder as long as the material has the magnetic properties.

Further, the auxiliary heating plate 69 may be formed by magnetic shunt alloy such as iron-nickel alloy having a curie point of 220-230 degrees centigrade. In a case in which the auxiliary heating plate 69 is formed by magnetic shunt alloy, the temperature rise of a non-paper passing area can be suppressed in a case of passing the paper having an A4R width or a width smaller than the A4R width.

The heat pipe 78 is contacted with the surface (hereinafter referred to as “outer surface”) of the concave portion 69b of the auxiliary heating plate 69 opposite to the lubricant 79. The heat pipe 78 is formed into a cylindrical shape of which the longitudinal direction corresponds to the belt width direction. For example, the heat pipe 78 is formed through pultrusion using a metal such as aluminum and the like. Solvent (not shown) such as water and the like is enclosed inside the heat pipe 78. The heat pipe 78 equalizes the temperature of the auxiliary heating plate 69, and in this way, the temperature of the fixing belt 50 can be equalized.

For example, compared with a case of using the magnetic shunt alloy, it can reduce the cost to arrange the heat pipe 78 at the outer surface of the concave portion 69b of the auxiliary heating plate 69 without using the magnetic shunt alloy. Further, in a case of magnetic shunt alloy, the heating efficiency of the fixing belt 50 is reduced if the temperature is higher than the curie point. In ac case in which the heat pipe 78 is arranged at the outer surface of the concave portion 69b of the auxiliary heating plate 69 without using the magnetic shunt alloy, the decrease in the heating efficiency of the fixing belt 50 is suppressed.

The shield 76 includes a main body portion 76a and a concave portion 76b. The main body portion 76a of the shield 76 faces the first wing 56a and the second wing 56b across the fixing belt 50 and faces the main body portion 69a of the auxiliary heating plate 69. The main body portion 76a of the shield 76 contacts with the main body portion 69a of the auxiliary heating plate 69. The main body portion 76a of the shield 76, similar to the main body portion 69a of the auxiliary heating plate 69, is also formed into an arc shape. The concave portion 76b of the shield 76 is recessed inward in the radial direction of the fixing belt 50 compared with the main body portion 76a. The concave portion 76b of the shield 76 faces the concave portion 69b of the auxiliary heating plate 69 across the heat pipe 78.

For example, the shield 76 is formed by a nonmagnetic material such as aluminum, copper and the like. The shield 76 shields the magnetic flux from the IH coil unit 52 and prevents the stay 77, the nip pad 53 and the like arranged inside the fixing belt 50 from being affected by the magnetic flux. The shield 76 is contacted with the auxiliary heating plate 69, which increases the heat capacity of the auxiliary heating plate 69.

The nip pad 53 presses the inner peripheral surface of the fixing belt 50 against the pressing roller 51 to form a nip 54 between the fixing belt 50 and the pressing roller 51. For example, the nip pad 53 is formed by heat-resistant polyphenylene sulfide resin (PPS), liquid crystal polymer (LCP), phenol resin (PF) and the like.

For example, a release layer and the like formed with a sheet or fluororesin having good sliding property and excellent abrasion resistance are arranged between the nip pad 53 and the fixing belt 50. With such a release layer and the like, the frictional resistance between the fixing belt 50 and the nip pad 53 is reduced.

For example, the pressing roller 51 includes heat-resistant silicon sponge, a silicon rubber layer and the like around a core bar. For example, a release layer formed by fluorine resin such as PFA resin and the like is arranged on the surface of the pressing roller 51. The pressing roller 51 presses against the nip pad 53 through a pressing mechanism 51a. The pressing roller 51 is rotated in a direction indicated by an arrow q by a motor 51b. The motor 51b is driven by a motor driving circuit 51c controlled by the main body control section 101.

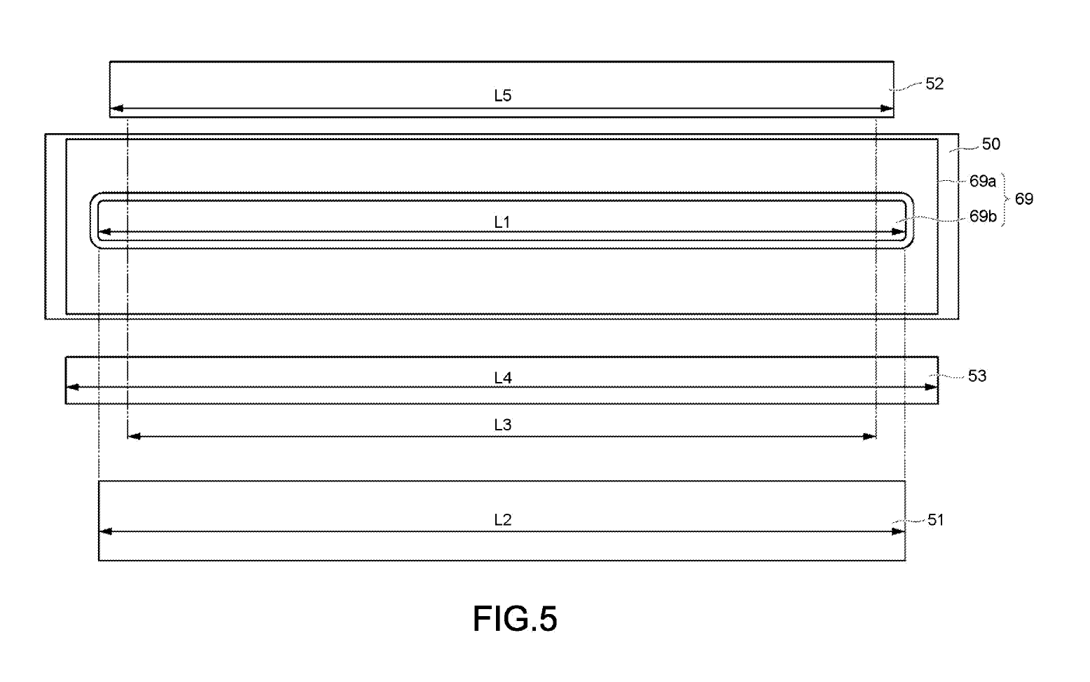

FIG. 5 is an illustration diagram illustrating the length L1 of the concave portion 69b of the auxiliary heating plate in the belt width direction according to the first embodiment.

In the following description, the length L1 of the concave portion 69b of the auxiliary heating plate 69 in the belt width direction is referred to as a “concave portion width”, and the length L2 of the pressing roller 51 in the belt width direction is referred to as a “pressing roller width”. The length L3 of a paper passing area (sheet P) in the belt width direction is referred to as a “sheet width”. The length L4 of the nip pad 53 in the belt width direction is referred to as a “nip pad width”. The length L5 of the IH coil unit 52 in the belt width direction is referred to as an “IH coil unit width”.

In addition, the sheet width L3 refers to the width of a sheet the short side of which is the longest within the used sheets. For example, the sheet width L3 is set to be equal to the width of the short side of A3-sized paper.

As shown in FIG. 5, the concave portion width L1 is equal to the pressing roller width L2. In addition, the concave portion width L1 may be larger than the pressing roller width L2.

The concave portion width L1 is larger than the sheet width L3.

The concave portion width L1 is smaller than the nip pad width L4 but larger than the IH coil unit width L5.

The concave portion width L1, the pressing roller width L2, the sheet width L3, the nip pad width L4 and the IH coil unit width L5 meet the following formula (1).

L4>L1≧L2>L5>L3 Formula (1):

The center thermistor 61 and the edge thermistor 62 detect the temperature of the fixing belt 50 and input the detected temperatures to the main body control section 101. The center thermistor 61 is arranged at the center of the fixing belt in the width direction.

The edge thermistor 62 is arranged at a position more outer than the IH coil unit 52 in the belt width direction. The edge thermistor 62 detects, with high precision, the temperature of the outer side in the belt width direction of the fixing belt 50 without being affected by the IH coil unit 52.

The main body control section 101 controls an IH control circuit 67 according to the detection results of the center thermistor 61 and the edge thermistor 62. The IH control circuit 67 controls the magnitude of the high-frequency current output by the inverter drive circuit 68 under the control of the main body control section 101. The fixing belt 50 maintains various control temperature ranges according to the output of the inverter drive circuit 68.

The thermostat 63 functions as a safety device of the fixing device 34. The thermostat 63 operates when the fixing belt 50 is abnormally heated and the temperature of the fixing belt 50 rises to a given cut-off threshold value. The current output to the IH coil unit 52 is cut off through the operation of the thermostat 63. When the current output to the IH coil unit 52 is cut off, the MFP 10 is no longer driven, and the abnormal heating of the fixing device 34 is suppressed.

The driving section 90 includes the axis 93 and a motor 92. The axis 93 is arranged parallel to the belt width direction. The motor 92 is driven by the motor driving circuit 51c. The axis 93 is rotated by the motor 92 in a direction indicated by an arrow h. The motor driving circuit 51c controls the motor 92 based on the detection result of the edge thermistor 62.

The auxiliary heating plate 69 is arranged on the axis 93. The auxiliary heating plate 69 is rotated, through the rotation of the axis 93, around the axis 93 in the direction indicated by the arrow h to be separated from the inner peripheral surface of the fixing belt 50.

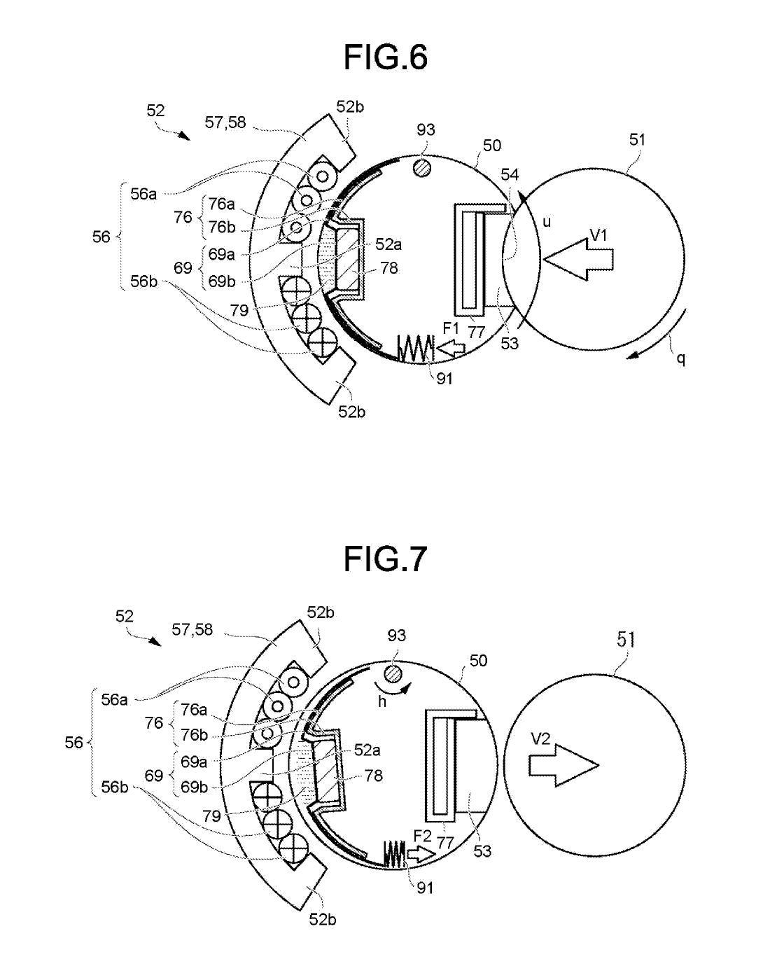

FIG. 6 is a side view illustrating a state in which the auxiliary heating plate 69 is contacted with the inner peripheral surface of the fixing belt 50 according to the first embodiment. FIG. 7 is a side view illustrating a state in which the auxiliary heating plate 69 is separated from the inner peripheral surface of the fixing belt 50 according to the first embodiment. In addition, for the sake of the convenience of description, the thermostat 63 and the like are not shown in FIG. 6 and FIG. 7.

As shown in FIG. 6 and FIG. 7, the driving section 90 rotates the axis 93 to contact the auxiliary, heating plate 69 with the inner peripheral surface of the fixing belt 50 or to separate the auxiliary heating plate 69 from the inner peripheral surface of the fixing belt 50. The heat pipe 78 and the shield 76 are moved together with the auxiliary heating plate 69 through the rotation of the axis 93. In addition, the driving section 90 may contact the auxiliary heating plate 69 with the inner peripheral surface of the fixing belt 50 or to separate the auxiliary heating plate 69 from the inner peripheral surface of the fixing belt 50 through a cam and a motor.

Hereinafter, a case in which the pressing roller 51 is moved in a direction indicated by an arrow V1 to form the nip 54 between the fixing belt 50 and the pressing roller 51 is referred to as a “nip formation time”. Further, a case in which the pressing roller 51 is moved in a direction indicated by an arrow V2 so as not to form the nip 54 between the fixing belt 50 and the pressing roller 51 is referred to as a “nip non-formation time”.

During the nip formation time, the auxiliary heating plate 69 is contacted with the inner peripheral surface of the fixing belt 50. On the other hand, during the nip non-formation time, the auxiliary heating plate 69 is separated from the inner peripheral surface of the fixing belt 50.

Hereinafter, the state of the nip formation time is described with reference to FIG. 6.

As shown in FIG. 6, the auxiliary heating plate 69 is energized in a direction indicated by an arrow F1 through the elastic force of the elastic member 91. The main body portion 69a of the auxiliary heating plate 69 is contacted with the inner peripheral surface of the fixing belt 50 through the elastic force of the elastic member 91.

When the auxiliary heating plate 69 is contacted with the inner peripheral surface of the fixing belt 50, the heat capacity of the fixing belt 50 is increased relatively. If the heat capacity of the fixing belt 50 is increased relatively, the temperature decrease of the paper passing area of the fixing belt 50 is suppressed, and the temperature rise of the non-paper passing area is suppressed as well. If the heat capacity of the fixing belt 50 is increased relatively, the heating of the fixing belt 50 is also equalized, and the temperature unevenness of the fixing belt 50 is suppressed even in a case of passing sheets continuously at a high speed.

The lubricant 79 is injected between the concave portion 69b of the auxiliary heating plate 69 and the inner peripheral surface of the fixing belt 50. The lubricant 79 reduces the frictional resistance between the inner peripheral surface of the fixing belt 50 and the auxiliary heating plate 69 even if the auxiliary heating plate 69 is contacted with the inner peripheral surface of the fixing belt 50. Further, the lubricant 79 reduces the frictional resistance between the inner peripheral surface of the fixing belt 50 and the nip pad 53 even if the nip pad 53 is contacted with the inner peripheral surface of the fixing belt 50.

Hereinafter, the state of the nip non-formation time is described with reference to FIG. 7.

As shown in FIG. 7, the axis 93 moves the auxiliary heating plate 69 in the direction indicated by the arrow F2 against the elastic force of the elastic member 91. The main body portion 69a of the auxiliary heating plate 69 is separated from the inner peripheral surface of the fixing belt 50 against the elastic force of the elastic member 91.

When the auxiliary heating plate 69 is separated from the inner peripheral surface of the fixing belt 50, the heat capacity of the fixing belt 50 is relatively decreased. If the heat capacity of the fixing belt 50 is relatively decreased, the waiting time such as the warming up time and the time taken to resume from sleep is reduced.

The fixing belt 50 includes the elastic layer 50e (refer to FIG. 3) such as a silicone rubber layer and the like, when the auxiliary heating plate 69 is separated from the inner peripheral surface of the fixing belt 50, the creep deformation of the elastic layer 50e of the fixing belt 50 is suppressed.

The pressing roller 51 includes a rubber layer such as the silicone rubber layer and the like, when the pressing roller 51 is separated from fixing belt 50, the creep deformation of the rubber layer of the pressing roller 51 is suppressed.

In addition, it is also applicable to separate the auxiliary heating plate 69 from the inner peripheral surface of the fixing belt 50 during the nip formation time and to contact the auxiliary heating plate 69 with the inner peripheral surface of the fixing belt 50 during the nip non-formation time. The auxiliary heating plate 69 may be contacted with and separated from the inner peripheral surface of the fixing belt 50 properly as occasion demands. The time for switching from the contacted state to the separated state between the auxiliary heating plate 69 and the inner peripheral surface of the fixing belt 50 may be adjusted by adjusting the rotation speed of the motor 92.

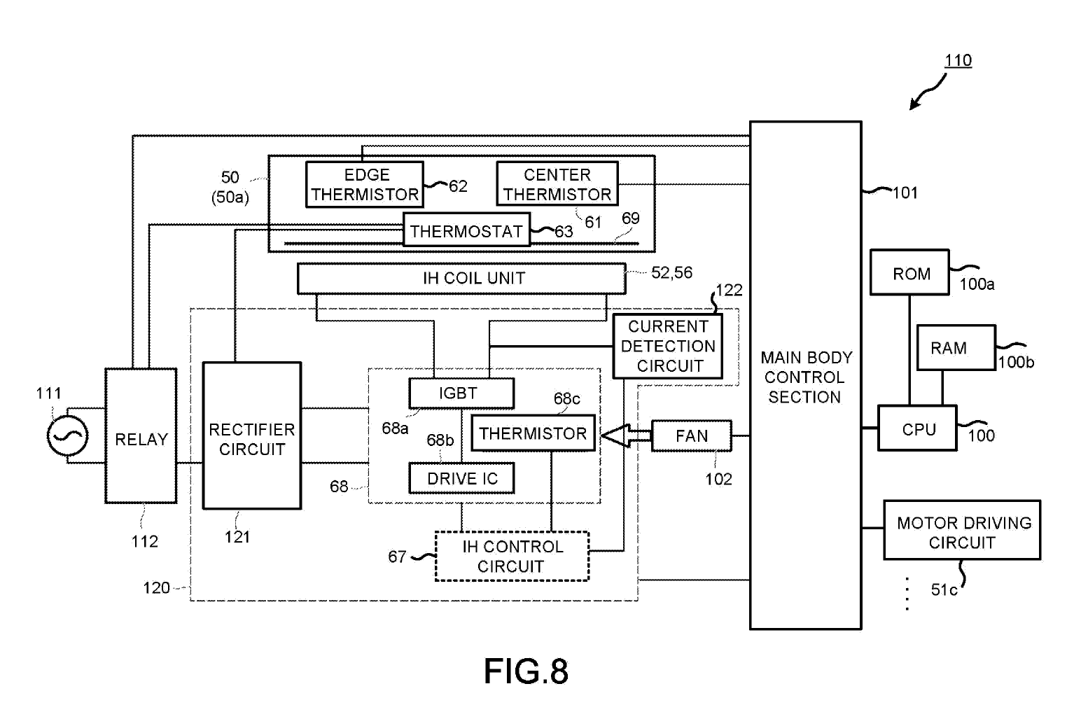

Hereinafter, a control system 110 mainly for the control of the IH coil unit 52 for enabling the fixing belt 50 to generate heat is described in detail with reference to FIG. 8.

FIG. 8 is a block diagram illustrating the control system mainly for the control of the IH coil unit 52 according to the first embodiment.

As shown in FIG. 8, the control system 110 includes a CPU 100, a read only memory (ROM) 100a, a random access memory (RAM) 100b, the main body control section 101, an IH circuit 120 and the motor driving circuit 51c.

The CPU 100 controls the whole system. The main body control section 101 receives a command from the CPU 100 to control the printer section 18 (refer to FIG. 1).

The main body control section 101 supplies power for the IH coil unit 52 through the IH circuit 120. The IH circuit 120 includes a rectifier circuit 121, the IH control circuit 67, the inverter drive circuit 68 and a current detection circuit 122.

The IH circuit 120 rectifies, with the rectifier circuit 121, the current input from an AC power supply 111 through a relay 112 and supplies the current to the inverter drive circuit 68.

The relay 112 cuts off the current from the AC power supply 111 when the thermostat 63 is cut off. The inverter drive circuit 68 includes a drive IC 68b of an IGBT element 68a and a thermistor 68c. The thermistor 68c detects the temperature of the IGBT element 68a. In a case in which the thermistor 68c detects the temperature rise of the IGBT element 68a, the main body control section 101 drives a fan 102 to cool the IGBT element 68a down.

The IH control circuit 67 controls the drive IC 68b according to the detection results of the center thermistor 61 and the edge thermistor 62. The IH control circuit 67 controls the drive IC 68b to control the output of the IGBT element 68a. The current detection circuit 122 sends the detection result of the output of the IGBT element 68a to the IH control circuit 67. The IH control circuit 67 controls the drive IC 68b according to the detection result of the current detection circuit 122 so that the power supplied to the coil 56 is constant

Hereinafter, the operation of the fixing device 34 in the warming up process is described.

As shown in FIG. 2, in the warming up process, the fixing device 34 rotates the pressing roller 51 in a direction indicated by an arrow q, and in this way, the fixing belt 50 is driven to rotate in a direction indicated by an arrow u. The IH coil unit 52 generates the magnetic flux to the fixing belt 50 through the application of the high-frequency current based on the inverter drive circuit 68.

The magnetic flux of the IH coil unit 52 is inducted to a first magnetic path (not shown) passing through the heating layer 50a of the fixing belt 50, in this way, the heating layer 50a generates heat. The magnetic flux of the IH coil unit 52 passing through the fixing belt 50 is inducted to a second magnetic path (not shown) passing through the auxiliary heating plate 69, in this way, the auxiliary heating plate 69 generates heat.

The heat of the auxiliary heating plate 69 is transferred to the fixing belt 50. The transfer of heat from the auxiliary heating plate 69 to the fixing belt 50 encourages the rapid warming up of the fixing belt 50.

As shown in FIG. 2, the IH control circuit 67 controls the inverter drive circuit 68 according to the detection results of the center thermistor 61 or the edge thermistor 62. The inverter drive circuit 68 supplies a given current for the coil 56.

Hereinafter, the operation of the fixing device 34 in the fixing operation is described.

After the temperature of the fixing belt 50 reaches the fixing temperature and the warming up is completed, if there is a printing request, the MFP 10 (refer to FIG. 1) starts the printing operation. The MFP 10 forms a toner image on the sheet P in the printer section 18 and then conveys the sheet P to the fixing device 34.

The MFP 10 passes the sheet P on which the toner image is formed through the nip 54 between the fixing belt 50 reaching the fixing temperature and the pressing roller 51. The fixing device 34 fixes the toner image on the sheet P. During the fixing process, the IH control circuit 67 controls the IH coil unit 52 to maintain the fixing belt 50 at the fixing temperature.

Through the fixing operation, the heat of the fixing belt 50 is absorbed by the sheet P. For example, in a case of passing sheets continuously at a high speed, a large quantity of heat is absorbed by the sheet P, thus, there is a case in which the fixing belt 50 with low heat capacity cannot be maintained at the fixing temperature. Through the transfer of heat from the auxiliary heating plate 69 to the fixing belt 50, the fixing belt 50 can be heated from the inner periphery thereof, which can compensate for the insufficiency of belt calorific value. The heating of the fixing belt 50 based on the auxiliary heating plate 69 can maintain the temperature of the fixing belt 50 at the fixing temperature even in the case of passing sheets continuously at a high speed

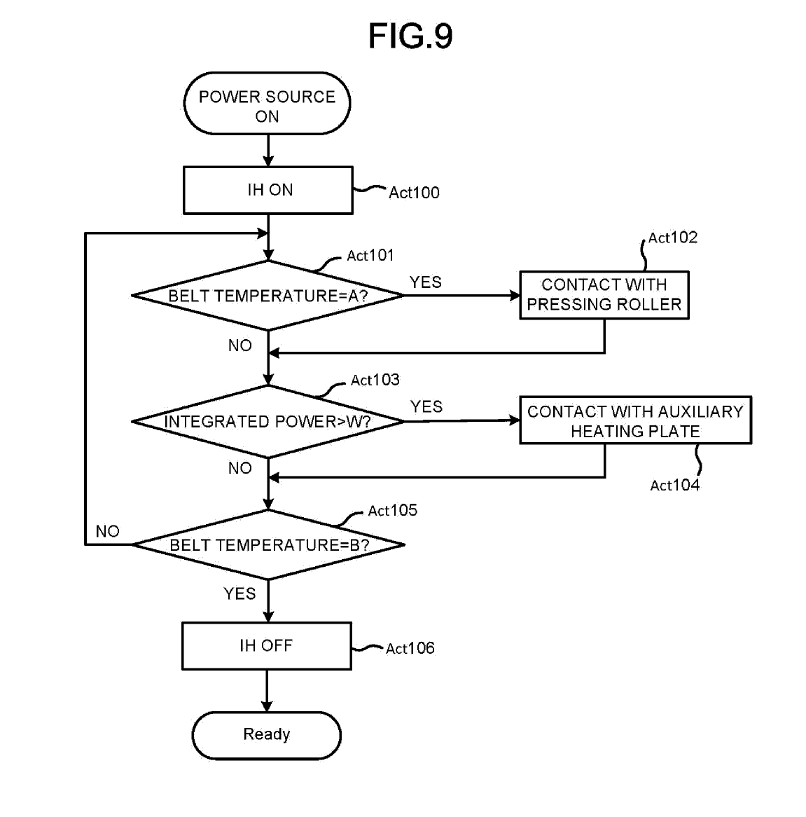

Hereinafter, the control of the fixing device 34 is described in detail with reference to FIG. 9.

FIG. 9 is a flowchart illustrating the control of the fixing device 34 according to the first embodiment.

As shown in FIG. 9, the power source of the MFP 10 (refer to FIG. 1) is turned on (hereinafter referred to as “power source ON”). Alternatively, the MFP 10 is resumed from a sleep mode (hereinafter referred to as “resuming from sleep”). In a case of power source ON or resuming from sleep, the main body control section 101 (refer to FIG. 8) turns on the IH coil unit 52 (“IH ON” in ACT 100).

In ACT 101, after the heating of the fixing belt 50 is started based on the IH coil unit 52, the given temperature that the fixing belt 50 reaches is set as a first temperature A. The first temperature A is a little higher or lower than the fixing temperature of the fixing belt 50. The first temperature A is set to be higher or lower than the fixing temperature as occasion demands.

The main body control section 101 determines whether or not the temperature (hereinafter referred to as “belt temperature”) of the fixing belt 50 is the first temperature A in ACT 101. In a case in which it is determined that belt temperature=A (YES in ACT 101), the main body control section 101 contacts the pressing roller 51 with the fixing belt 50 (“contact with pressing roller” in ACT 102). In a case in which it is determined that the belt temperature is not equal to A (NO in ACT 101), the main body control section 101 executes the processing in ACT 103.

Hereinafter, the integrated amount of the power supplied to the IH coil unit 52 is referred to as “integrated power”. The main body control section 101 determines whether or not the integrated power is greater than the given value W in ACT 103. Whether or not the temperature of the auxiliary heating plate 69 is higher than a given temperature is estimated according to whether or not the integrated power is greater than the given value W. In a case in which it is determined that integrated power>W (YES in ACT 103), the main body control section 101 contacts the auxiliary heating plate 69 with the inner peripheral surface of the fixing belt 50 (“contact with auxiliary heating plate” in ACT 104). In a case in which it is determined that the integrated power is not greater than W (NO in ACT 103), the main body control section 101 executes the processing in ACT 105.

In ACT 105, the given temperature that the fixing belt 50 reaches is set as a second temperature B. The second temperature B is a standby temperature (ready temperature) of the fixing device 34 when the warming up is completed. The second temperature B may be higher or lower than the first temperature A.

The main body control section 101 determines whether or not the belt temperature is the second temperature B in ACT 105. In a case in which it is determined that the belt temperature is not equal to the second temperature B (NO in ACT 105), the main body control section 101 returns to execute the processing in ACT 101. In a case in which it is determined that belt temperature=B (YES in ACT 105), the main body control section 101 turns off the IH coil unit 52 (“IH OFF” in ACT 106). Then, the main body control section 101 maintains the belt temperature at the ready temperature.

In accordance with the first embodiment, the lubricant 79 is injected into the concave portion 69b of the auxiliary heating plate 69. In this way, the inner peripheral surface of the fixing belt 50 can be lubricated by the lubricant 79. As a result, the frictional resistance between the inner peripheral surface of the fixing belt 50 and the auxiliary heating plate 69 can be reduced. Thus, even if the auxiliary heating plate 69 is contacted with the inner peripheral surface of the fixing belt 50, it can be prevented that the rotation of the fixing belt 50 becomes harder due to the frictional resistance, in this way, the fixing operation is speeded up.

Further, the frictional resistance between the nip pad 53 and the inner peripheral surface of the fixing belt 50 can be reduced by the lubricant 79. Thus, even if the nip pad 53 is contacted with the inner peripheral surface of the fixing belt 50, it can be prevented that the rotation of the fixing belt 50 becomes harder due to the frictional resistance, in this way, the fixing operation is speeded up.

Compared with a case of impregnating fixing belt with the lubricant, the lubricant 79 is prevented from being depleted by being injected into the concave portion 69b.

The concave portion 69b faces the first convex portion 52a of the IH coil unit 52 across the fixing belt 50. There is almost no effect on the formation of the magnetic path based on the magnetic flux of the IH coil unit 52 in the area facing the first convex portion 52a. The magnetic path based on the magnetic flux of the IH coil unit 52 is formed efficiently by arranging the concave portion 69b in a manner of facing the first convex portion 52a.

The length J1 of the concave portion 69b along the rotation direction of the fixing belt 50 is longer than a length J2 of the first convex portion 52a along the rotation direction of the fixing belt 50, and in this case, the inner peripheral surface of the fixing belt 50 is lubricated efficiently compared with a case in which the length J1 of the concave portion 69b is shorter than the length J2 of the first convex portion 52a (J1<J2). Further, compared with a case in which J1<J2, more lubricant 79 is injected into the concave portion 69b, which can suppress the reduction of the lubricant 79.

The concave portion width L1 is equal to or larger than the pressing roller width L2 (L1≧L2), and in this case, the rotation load of the fixing belt 50 can be reduced compared with a case in which L1<L2.

The concave portion width L1 is larger than the sheet width L3 (L1>L3), and in this case, the heating of the fixing belt 50 in the entire paper passing area can be equalized compared with a case in which L1≦L3.

The driving section 90 relatively moves the inner peripheral surface of the fixing belt 50 and the auxiliary heating plate 69. The relative movement (contact or separation) of the inner peripheral surface of the fixing belt 50 and the auxiliary heating plate 69 relatively increases or decreases the heat capacity of the fixing belt 50. Through the relative increase in the heat capacity of the fixing belt 50, the temperature unevenness of the fixing belt 50 is suppressed even in a case of passing sheets continuously at a high speed. Through the relative decrease in the heat capacity of the fixing belt 50, the waiting time such as the warming up time and the time taken to resume from sleep is reduced.

The main body control section 101 carries out a control to contact the auxiliary heating plate 69 with the inner peripheral surface of the fixing belt 50 or to separate the auxiliary heating plate 69 from the inner peripheral surface of the fixing belt 50 based on the integrated power. The main body control section 101 estimates the temperature of the auxiliary heating plate 69 according to the integrated power, in this way, there is no need to arrange a detection member for detecting the temperature of the auxiliary heating plate 69, which simplifies the constitution of the fixing device 34.

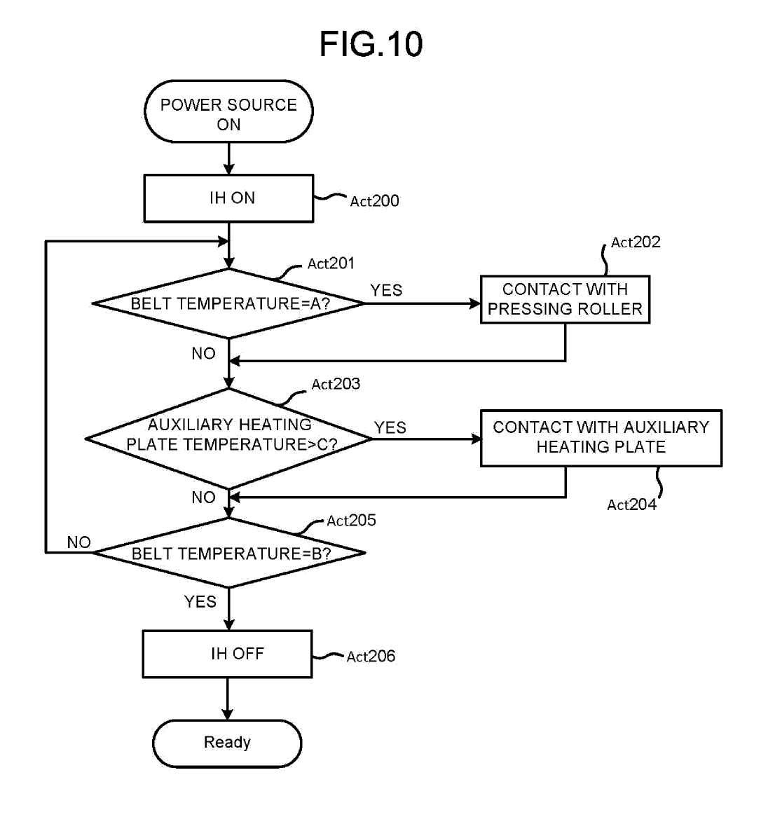

Hereinafter, the control of a fixing device according to a second embodiment is described with reference to FIG. 10. In the second embodiment, the control is carried out based on the temperature of the auxiliary heating plate 69, which is different from the first embodiment in which the control is carried out based on the integrated power. The same components in the second embodiment as those described in the first embodiment are indicated by the same reference numerals, and the detailed description thereof is not repeated.

FIG. 10 is a flowchart illustrating the control of the fixing device according to the second embodiment.

As shown in FIG. 10, in a case of power source ON or resuming from sleep, the main body control section 101 turns on the IH coil unit 52 (“IH ON” in ACT 200).

The main body control section 101 determines whether or not the belt temperature is the first temperature A in ACT 201. In a case in which it is determined that belt temperature=A (YES in ACT 201), the main body control section 101 contacts the pressing roller 51 with the fixing belt 50 (“contact with pressing roller” in ACT 202). In a case in which it is determined that the belt temperature is not equal to A (NO in ACT 201), the main body control section 101 executes the processing in ACT 203.

In ACT 203, the given temperature detected by a detection member for detecting the temperature of the auxiliary heating plate 69 is set as a detected temperature C. The main body control section 101 determines whether or not the temperature (hereinafter referred to as an “auxiliary heating plate temperature”) of the auxiliary heating plate 69 is higher than the detected temperature C in ACT 203. In a case in which it is determined that auxiliary heating plate temperature>C (YES in ACT 203), the main body control section 101 contacts the auxiliary heating plate 69 with the inner peripheral surface of the fixing belt 50 (“contact with auxiliary heating plate” in ACT 204). In a case in which it is determined that the auxiliary heating plate temperature is not higher than C (NO in ACT 203), the main body control section 101 executes the processing in ACT 205.

The main body control section 101 determines whether or not the belt temperature is the second temperature B in ACT 205. In a case in which it is determined that the belt temperature is not equal to the second temperature B (NO in ACT 205), the main body control section 101 returns to execute the processing in ACT 201. In a case in which it is determined that belt temperature=B (YES in ACT 205), the main body control section 101 turns off the IH coil unit 52 (“IH OFF” in ACT 206). Then, the main body control section 101 maintains the belt temperature at the ready temperature.

In accordance with the second embodiment, the main body control section 101 carries out a control to contact the auxiliary heating plate 69 with the inner peripheral surface of the fixing belt 50 or to separate the auxiliary heating plate 69 from the inner peripheral surface of the fixing belt 50 based on the auxiliary heating plate temperature. Compared with a case of estimating the temperature of the auxiliary heating plate 69, the error in the determination is much smaller in a case of detecting the auxiliary heating plate temperature directly, thus, the control of the fixing device 34 can be carried out with high precision.

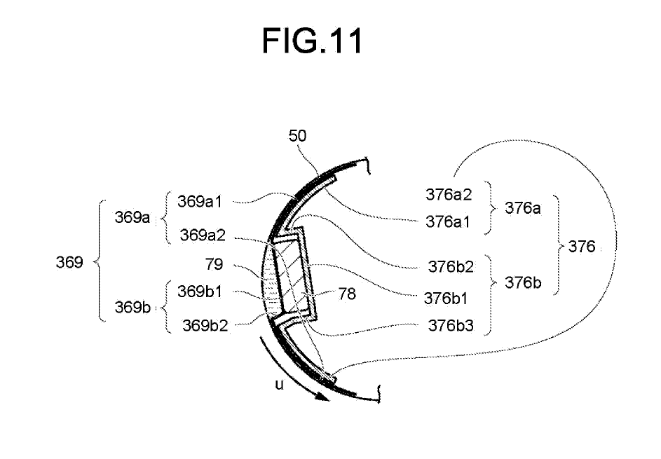

Hereinafter, a fixing device according to a third embodiment is described with reference to FIG. 11. In the third embodiment, the depth of the concave portion at the downstream side of the rotation direction (indicated by an arrow u) of the fixing belt is deeper than that at the upstream side, which is different from the first embodiment in which the depth of the concave portion is constant. The same components in the third embodiment as those described in the first embodiment are indicated by the same reference numerals, and the detailed description thereof is not repeated.

FIG. 11 is a side view of the main portions of a fixing device according to the third embodiment. In addition, the IH coil unit 52, the thermostat 63 and the like are not shown in FIG. 11.

As shown in FIG. 11, an auxiliary heating plate 369 according to the third embodiment includes a main body portion 369a and a concave portion 369b. The main body portion 369a is formed into an arc shape along the inner peripheral surface of the fixing belt 50. The concave portion 369b is recessed inward in the radial direction of the fixing belt 50 compared with the main body portion 369a. The lubricant 79 is injected into the concave portion 369b.

The main body portion 369a includes a first arcuate portion 369a1 and a second arcuate portion 369a2. The first arcuate portion 369a1 is positioned at the upstream side of the rotation direction of the fixing belt 50. The second arcuate portion 369a2 is positioned at the downstream side of the rotation direction of the fixing belt 50.

The concave portion 369b includes a first wall portion 369b1 and a second wall portion 369b2. The first wall portion 369b1 is formed into a straight line, of which the end at the downstream side of the rotation direction of the fixing belt 50 is inclined inward in the radial direction of the fixing belt 50 compared with the end at the upstream side. The first wall portion 369b1 is connected with the downstream end of the first arcuate portion 369a1 in the rotation direction of the fixing belt 50. The second wall portion 369b2 is connected with the first wall portion 369b1 and the upstream end of the second arcuate portion 369a2 in the rotation direction of the fixing belt 50.

The heat pipe 78 is contacted with the outer surface of the first wall portion 369b1 of the concave portion 369b of the auxiliary heating plate 369.

A shield 376 according to the third embodiment includes a main body portion 376a and a concave portion 376b. The main body portion 376a of the shield 376, similar to the main body portion 369a of the auxiliary heating plate 369, is also formed into an arc shape. The concave portion 376b of the shield 376 is recessed inward in the radial direction of the fixing belt 50 compared with the main body portion 376a.

The main body portion 376a of the shield 376 includes a first arcuate portion 376a1 and a second arcuate portion 376a2. The first arcuate portion 376a1 is positioned at the upstream side of the rotation direction of the fixing belt 50. The second arcuate portion 376a2 is positioned at the downstream side of the rotation direction of the fixing belt 50.

The concave portion 376b of the shield 376 includes a bottom wall portion 376b1, a first side wall portion 376b2 and a second side wall portion 376b3. The bottom wall portion 376b1 is formed into a straight line, of which the end at the downstream side of the rotation direction of the fixing belt 50 is inclined inward in the radial direction of the fixing belt 50 compared with the end at the upstream side. The bottom wall portion 376b1 faces the first wall portion 369b1 of the auxiliary heating plate 369 across the heat pipe 78. The first side wall portion 376b2 is connected with the bottom wall portion 376b1 and the downstream end of the first arcuate portion 376a1 in the rotation direction of the fixing belt 50. The second side wall portion 369b3 is connected with the bottom wall portion 376b1 and the upstream end of the second arcuate portion 376a2 in the rotation direction of the fixing belt 50.

In accordance with the third embodiment, the depth of the concave portion 369b at the downstream side of the rotation direction of the fixing belt 50 is deeper than that at the upstream side, in this way, the holding force for holding the lubricant 79 is increased compared with a case in which the depth of the concave portion is constant.

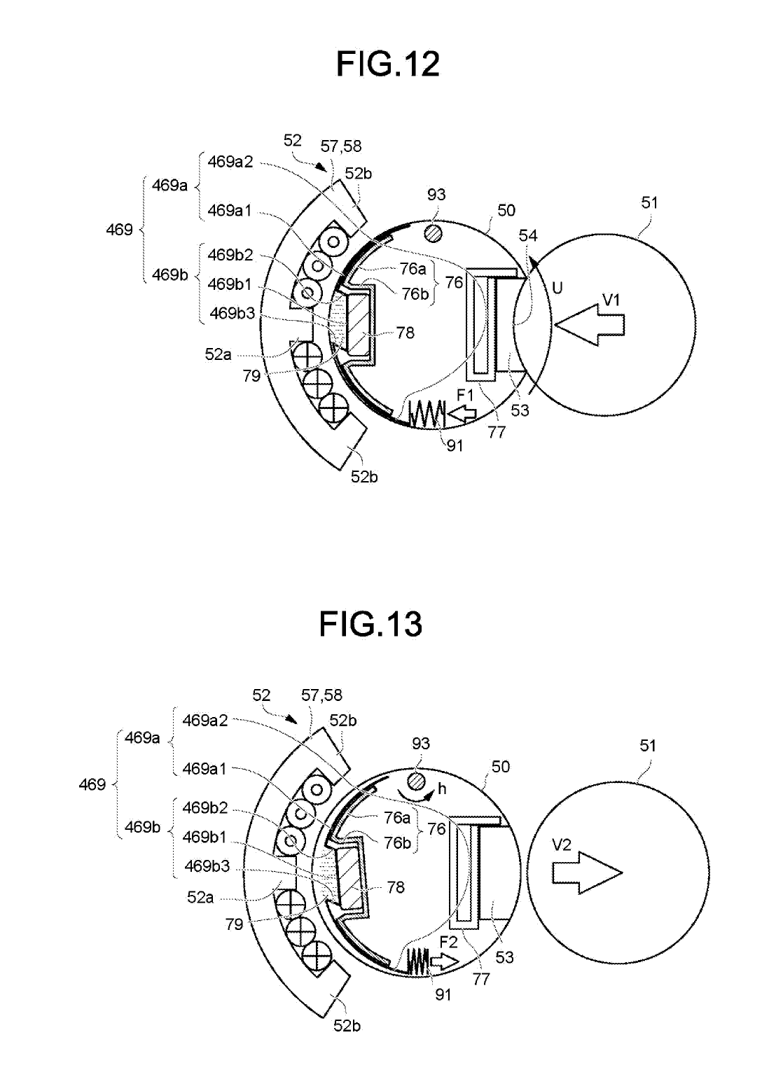

Hereinafter, a fixing device according to a fourth embodiment is described with reference to FIG. 12 and FIG. 13. In the fourth embodiment, the second side wall portion of the concave portion is positioned more and more towards the downstream side of the rotation direction (indicated by an arrow u) of the fixing belt as it goes inward in the radial direction of the fixing belt, which is different from the first embodiment in which the depth of the concave portion is constant. The same components in the fourth embodiment as those described in the first embodiment are indicated by the same reference numerals, and the detailed description thereof is not repeated.

FIG. 12 is a side view illustrating a state in which an auxiliary heating plate 469 is contacted with the inner peripheral surface of the fixing belt 50 according to the fourth embodiment, which is equivalent to FIG. 6. FIG. 13 is a side view illustrating a state in which the auxiliary heating plate 469 is separated from the inner peripheral surface of the fixing belt 50 according to the fourth embodiment, which is equivalent to FIG. 7. In addition, for the sake of the convenience of description, the thermostat 63 and the like are not shown in FIG. 12 and FIG. 13.

As shown in FIG. 12 and FIG. 13, the auxiliary heating plate 469 according to the fourth embodiment includes a main body portion 469a and a concave portion 469b. The main body portion 469a is formed into an arc shape along the inner peripheral surface of the fixing belt 50. The concave portion 469b is recessed inward in the radial direction of the fixing belt 50 compared with the main body portion 469a. The lubricant 79 is injected into the concave portion 469b.

The main body portion 469a includes a first arcuate portion 469a1 and a second arcuate portion 469a2. The first arcuate portion 469a1 is positioned at the upstream side of the rotation direction of the fixing belt 50. The second arcuate portion 469a2 is positioned at the downstream side of the rotation direction of the fixing belt 50.

The concave portion 469b includes a bottom wall portion 469b1, a first side wall portion 469b2 and a second side wall portion 469b3. The bottom wall portion 469b1 is formed into a straight line parallel to a tangent direction of the inner peripheral surface of the fixing belt 50 in an area opposite to the first convex portion 52a. The heat pipe 78 is contacted with the outer surface of the bottom wall portion 469b1 of the concave portion 469b of the auxiliary heating plate 469.

The first side wall portion 469b2 is connected with the downstream end of the first arcuate portion 469a1 in the rotation direction of the fixing belt 50 and a first end of a first wing 56a of the bottom wall portion 469b1.

The second side wall portion 469b3 is connected with the upstream end of the second arcuate portion 469a2 in the rotation direction of the fixing belt 50 and a second end of a second wing 56b of the bottom wall portion 469b1. The second side wall portion 469b3 is positioned more and more towards the downstream side of the rotation direction (indicated by an arrow u) of the fixing belt 50 as it goes inward in the radial direction of the fixing belt 50.

In accordance with the fourth embodiment, the second side wall portion 469b3 of the concave portion 469b is positioned more and more towards the downstream side of the rotation direction of the fixing belt 50 as it goes inward in the radial direction of the fixing belt 50, in this way, the holding force for holding the lubricant 79 is increased compared with a case in which the second side wall portion 469b3 is positioned more and more towards the upstream side of the rotation direction of the fixing belt 50 as it goes inward in the radial direction of the fixing belt 50

As shown in FIG. 13, the lubricant 79 is still held due to the inclination of the second side wall portion 469b3 even if the auxiliary heating plate 469 is separated from the inner peripheral surface of the fixing belt 50.

Hereinafter, a modification of the embodiment is described.

The fixing device 34 according to the embodiments described above may stretch the fixing belt 50 with a plurality of rollers. The number of the rollers for stretching the fixing belt 50 may be set properly.

The fixing device 34 according to the embodiments described above may be provided with such an auxiliary heating plate that does not generate heat itself through the induction current generated by the IH coil unit 52. No specific limitation is given to the auxiliary heating plate as long as it can assist in the heating of the heating layer 50c based on the induction current.

In accordance with at least one embodiment described above, the lubricant 79 is injected into the concave portion 69b of the auxiliary heating plate 69. With the lubricant 79, the inner peripheral surface of the fixing belt 50 can be lubricated, and the frictional resistance between the inner peripheral surface of the fixing belt 50 and the auxiliary heating plate 69 can be reduced. Thus, it can be prevented that the rotation of the fixing belt 50 becomes harder due to the frictional resistance even if the auxiliary heating plate 69 is contacted with the inner peripheral surface of the fixing belt 50, in this way, the fixing operation is speeded up.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A fixing device comprising:
an induction current generation section configured to generate induction current;
an endless fixing belt configured to include a heating layer which generates heat through the induction current;
an auxiliary heating section configured to be contacted with the inner peripheral surface of the fixing belt to assist in the heating of the heating layer based on the induction current;
a concave portion configured to be formed in the auxiliary heating section to face the inner peripheral surface of the fixing belt, wherein the concave portion is recessed inward of the radial direction of the endless fixing belt compared with a main body portion; and
lubricant configured to be injected into the concave portion.

2. The fixing device according to claim 1, wherein
a convex portion protruding from the outside of the fixing belt towards the fixing belt is formed in the induction current generation section; and
the concave portion faces the convex portion across the fixing belt.

3. The fixing device according to claim 2, wherein
the length of the concave portion along the rotation direction of the fixing belt is longer than that of the convex portion along the rotation direction of the fixing belt.

4. The fixing device according to claim 1, wherein
the depth of the concave portion at the downstream side of the rotation direction of the fixing belt is deeper than that at the upstream side.

5. The fixing device according to claim 1, further comprising:
a nip pad arranged inside the fixing belt; and
a pressing roller configured to press the nip pad; wherein
the length L1 of the concave portion in the width direction of the fixing belt is equal to or longer than the length L2 of the pressing roller in the width direction of the fixing belt.

6. The fixing device according to claim 1, wherein
the length L1 of the concave portion in the width direction of the fixing belt is longer than the length L3 of a paper passing area in the width direction of the fixing belt.

7. The fixing device according to claim 1, further comprising:
a driving section configured to relatively move the auxiliary heating section and the inner peripheral surface of the fixing belt.

8. The fixing device according to claim 7, further comprising:
a control section configured to carry out a control to contact the auxiliary heating section with the inner peripheral surface of the fixing belt or to separate the auxiliary heating section from the inner peripheral surface of the fixing belt based on integrated power of the induction current generation section.

9. The fixing device according to claim 7, further comprising:
a control section configured to carry out a control to contact the auxiliary heating section with the inner peripheral surface of the fixing belt or to separate the auxiliary heating section from the inner peripheral surface of the fixing belt based on the temperature of the auxiliary heating section.

10. An image forming apparatus comprising:
an image forming section configured to form an image on an image receiving medium; and
the fixing device according to claim 1 configured to fix the image on the image receiving medium.
